(19) United States
(12) Patent Application Publication
(10) Pub. No.: US 2009/0007352 A1
(43) Pub. Date: Jan. 8, 2009

(54) Cleaner

(75) Inventors: Tsuyoshi Komine, Hyogo (JP); Hirokazu Suruga, Osaka (JP)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: BIG ALPHA CO., INC., Hyogo (JP)

(21) Appl. No.: 12/281,275

(22) PCT Filed: Feb. 2, 2007
(86) PCT No.: PCT/JP2007/051786

§ 371 Date: Aug. 29, 2008

(30) Foreign Application Priority Data
Mar. 10, 2006 (JP) 2006-065163

(51) Int. Cl. B08B 9/04

(52) U.S. Cl. 15/104.16

(57) ABSTRACT

Provided is a cleaner that can clean an inside wall surface defining a hollow portion to be cleaned even if the distance between the center of the hollow portion to the inside wall surface varies; the cleaner being able to adjust the level of pressure (force) applied against the inside wall surface; and being able to clean the inside wall surface by applying optimum pressing force, depending on how dirty the inside wall surface is, and simply by moving the cleaner in a back-and-forth movement direction relative to the hollow portion. The cleaner includes: a shaft 10; and a cleaning portion 20 attached around the outside surface of the shaft 10. The cleaning portion 20 includes: a plurality of cleaning members 30, each of which is made of an elastic material, has a larger diameter than the diameter of an opening of a hollow portion 101, and has a continuous annular outside surface; and a holding member(s) 40 that holds the cleaning members 30 and has a smaller diameter than the diameter of the opening of the hollow portion 101. The cleaning members 30 and the holding member(s) 40 can be rearranged and replaced with each other when they are attached to the shaft 10.

### BACKGROUND

1. Field of the Invention

The present invention relates to a cleaner for cleaning an inside wall surface defining a hollow portion of an object to be cleaned, examples of which include mechanical components, and various kinds of equipment and products.

2. Description of Related Art

Various types of cleaners that are used to clean the inside wall surface defining a generally-cylindrical hollow portion formed in various machine components, and various kinds of equipment and products have been conventionally known. The major type of examples of such cleaners is a type that has a brush portion and uses this brush portion to clean the inside wall surface. When the brush portion of this conventional type of cleaner is used to clean the inside wall surface, the tips of brush bristles constituting the brush portion come into contact with the inside wall surface of the hollow portion. Consequently, in addition to operating the cleaner to move it back and forth relative to the axial direction of the hollow portion, it is necessary to rotate the cleaner relative to the inside wall surface, or to rotate the relevant machine component or similar relative to the brush portion. Also, the above-described point-contact may cause scratches on the inside wall surface.

Moreover, there is a type of pipe cleaner for removing dirt in a pipeline, that can move within the pipeline, functions as a cutting head, and has a propulsion element including pivot joints between individual components. Such a pipe cleaner is equipped with a plurality of collars, which are independent from each other, for removing dirt in a pipeline (see, for example, Japanese Patent Application (Laid-Open) Publication No. S60-34782).

Also, a cylindrical-inside-surface cleaner composed of a vibration body, a brush attached around the periphery of the vibration body, and a vibrator for causing vibration to the vibration body, has been introduced. This cylindrical-inside-surface cleaner is configured so that the brush is composed from alternately arranged brush members, which are implanted around the periphery of the vibration body, and short-cylindrical spacers; and the vibrator gives vibration to each brush member so that the brush members clean the cylindrical inside surface (see, for example, Japanese Patent Application Laid-Open (Kokai) Publication No. H05-293454).

However, the pipe cleaner disclosed in Japanese Patent Application (Laid-Open) Publication No. S60-34782 is not configured so that the respective collars can be rearranged or exchanged with each other. Also, since each collar is provided independently, the collars cannot complement each other so that they may change, for example, their elastic force or hardness, depending on the diameter of a pipe or how dirty the pipe is. Therefore, the allowable range of the inside diameter of a pipe that can be cleaned by this pipe cleaner is narrow, and the fact is that the pipe cleaner is used to clean a pipe with a specified diameter. Moreover, the pipe cleaner cannot adjust the level of pressure (force) applied against the inside wall surface (inside surface) of the hollow portion of the pipe, and it is difficult to clean the inside wall surface by adjusting the level of force and applying optimum force depending on how dirty the inside wall surface is. Also, pluralities of notches that extend from the center of the collar to its outside surface are formed in each collar.

Similarly, regarding the cylindrical-inside-surface cleaner disclosed in Japanese Patent Application Laid-Open (Kokai) Publication No. H05-293454, the brush members implanted around the periphery of the vibration body and the spacers cannot be replaced with each other or rearranged. As a result, like in the case of Japanese Patent Application Laid-Open (Kokai) Publication No. S60-34782, the cylindrical-inside-surface cleaner is used to clean a pipe with a specified diameter, and cannot adjust the level of pressure (force) applied against the cylindrical inside surface. Since the brush members are used to clean the cylindrical inside surface, it is necessary as described above, in addition to operating the cylindrical-inside-surface cleaner to move it back and forth relative to the axial direction of the cylindrical inside surface (hollow portion), to rotate the cleaner relative to the cylindrical inside surface, or to rotate the relevant machine component or similar relative to the brush portion.

### SUMMARY

The present invention was devised in light of the circumstances described above. It is an object of the invention to provide a cleaner that can clean an inside wall surface defining a hollow portion to be cleaned even if the distance between the center of the hollow portion to the inside wall surface varies; that can adjust the level of pressure (force) applied against the inside wall surface; and that can clean the inside wall surface by applying optimum pressure (force), depending on how dirty the inside wall surface is, and simply by moving the cleaner in a back-and-forth movement direction relative to the hollow portion.

In order to achieve the above-described object, a cleaner for cleaning an inside wall surface defining a hollow portion is provided according to an aspect of the present invention, wherein the cleaner includes: a shaft; and a cleaning portion attached around the outside surface of the shaft. The cleaning portion includes: a plurality of cleaning members, each of which is made of an elastic material, has a larger diameter than the diameter of an opening of the hollow portion, and has a continuous annular outside surface; and a holding member that holds the cleaning members and has a smaller diameter than the diameter of an opening of the hollow portion; and wherein the cleaning members and the holding member can be rearranged and replaced with each other when attached to the shaft.

With the cleaner having the above-described configuration, the cleaning members and the holding members, which constitute the cleaning portion, can be rearranged and replaced with each other when they are attached to the shaft. As a result, an arbitrary number of cleaning members and holding members can be placed in arbitrary order; for example, repeating sets of one cleaning member and one holding member can be placed, or repeating sets of three cleaning members and one holding member can be placed, or repeating sets of one cleaning member and three holding members can be placed.

If the case where repeating sets of one cleaning member and one holding member are placed is compared with the case where repeating sets of three cleaning members and one holding member are placed, the latter case results in a longer length of one set of cleaning members in a back-and-forth movement direction relative to the hollow portion. Since the cleaning members are made of an elastic material, if the length of the cleaning member(s) in the back-and-forth movement direction is increased, it becomes difficult for the cleaning members to change their shape in a diameter direction and a lengthwise direction, and the pressure (force) applied against the inside wall surface of the hollow portion becomes stronger. As a result, the level of pressure (force) applied against the inside wall surface of the hollow portion can be adjusted by selecting the allocation (arrangement) of the cleaning members and the holding members. Therefore, the cleaner can clean a wide range of hollow portion sizes.

Furthermore, since each cleaning member has a larger diameter than the diameter of an opening of the hollow portion and has a continuous annular outside surface, the side face of the cleaning member comes into contact with the inside wall surface of the hollow portion in its circumferential direction (along the inside surface of the hollow portion). As a result, the inside wall surface can be cleaned with certainty simply by moving the cleaning portion back and forth relative to the hollow portion without rotating the cleaning portion relative to the inside wall surface of the hollow portion. Since each holding member has a smaller diameter than the diameter of the opening of the hollow portion, the holding member does not contact the inside wall surface of the hollow portion and can form a space between the adjacent cleaning members and the inside wall surface of the hollow portion. As a result, it is possible to retain, in this space, objects removed by the cleaning members from the inside wall surface of the hollow portion. Consequently, the removed objects retained in this space can be easily discharged out of the hollow portion by pulling the cleaning portion out of the hollow portion.

Incidentally, a “sectional shape” referred to regarding this invention includes the case where an envelope of a cross-section of the cleaner as taken generally perpendicularly to the back-and-forth direction of the cleaner is circular, i.e., where the cleaner is cylindrical; and other cases where the envelope of the cross-section of the cleaner is of a generally-triangular shape formed by a curved line, a generally-quadrangular shape formed by a curved line, a generally-polygonal shape formed by a curved line, a generally-triangular shape with three curved vertexes, a generally-quadrangular shape with four curved vertexes, or a generally-polygonal shape with more than four curved vertexes.

With the cleaner according to the present invention, the cleaning members and the holding members can be rearranged and replaced with each other when attached to the shaft. As a result, the level of pressure (force) applied against the inside wall surface of the hollow portion can be adjusted by selecting the allocation (arrangement) of the cleaning members and the holding members. Therefore, the cleaner can clean a wide range of hollow portion sizes. Also, since each cleaning member has a larger diameter than the diameter of the opening of the hollow portion and has a continuous annular outside surface, the side face of the cleaning member comes into contact with the inside wall surface of the hollow portion in its circumferential direction. As a result, the inside wall surface can be cleaned with certainty simply by moving the cleaning portion back and forth relative to the hollow portion without rotating the cleaning portion relative to the inside wall surface of the hollow portion.

### DETAILED DESCRIPTION OF PREFERRED EMBODIMENTS

A cleaner according to preferred embodiments of the invention will be described below with reference to the attached drawings. The embodiments described below are for the purpose of describing this invention, but the invention is not limited only to those embodiments. Accordingly, this invention can be utilized in various ways unless those utilizations depart from the gist of the invention.

FIG. 1 is a partly sectional side view of a cleaner according to an embodiment of the present invention. FIG. 2 is a cross-sectional view of the cleaner shown in FIG. 1 as taken along line II-II. FIG. 3 is a cross-sectional view of the cleaner shown in FIG. 1 as taken along line III-III. FIG. 4 is an exploded perspective view of the cleaner shown in FIG. 1. FIG. 5 is a cross-sectional view of part of a tool holder having a hollow portion to be cleaned by the cleaner according to this embodiment. FIG. 6 is a cross-sectional view showing the state where the cleaner according to this embodiment is inserted into the hollow portion of the tool holder shown in FIG. 5. FIGS. 7 and 8 are partly sectional views of the cleaner shown in FIG. 1, illustrating the state where cleaning members and holding members of the cleaner are rearranged. In FIG. 4, some of the cleaning members and holding members provided on the cleaner are omitted for ease of comprehension.

In this embodiment, one side of the cleaner—where a cleaning portion is located—is referred to as the “top-end side,” while the other side of the cleaner—where a grip to be held by a user is located—is referred to as the “base-end side.”

As shown in FIGS. 1 to 6, a cleaner 1 according to an embodiment of the invention includes a cylindrical shaft 10 and a cleaning portion 20 attached around the outside surface of the shaft 10.

A cleaning-members-mounting portion 11 for mounting the cleaning portion 20 is formed at the top-end side of the shaft 10, while a grip 13 to be held by a user is formed on the base-end side of the shaft 10. The cleaning-members-mounting portion 11 is of a cylindrical shape having a smaller diameter than that of the base-end side of the shaft 10. A stepped portion 14 formed by the difference between these diameters locks the base-end side of the cleaning portion 20. Also, an external thread 12 that engages with an internal thread 16 formed at a nut 15 (described later in detail) is formed at the top end of the cleaning-members-mounting portion 11.

The cleaning portion 20 is composed of a plurality of cleaning members 30 and a plurality of holding members 40 for holding the cleaning members 30. Each cleaning member 30 is made of an elastic material; has a generally-cylindrical through-hole 31 in its approximately central area; has a larger diameter (D₃₀) than the diameter of an opening (d) of a cylindrical hollow portion 101 formed in a tool holder 100 (see FIGS. 5 and 6); and is hollow and of a generally-disk-like shape having a continuous annular outside surface. In other words, the outline of a cross-section of this cleaning member 30 (the shape defined by the periphery of the cleaning member 30) as taken generally perpendicularly to the direction of back-and-forth movement of the cleaner 1 relative to the hollow portion 101 (the direction along which the cleaning members 30 and the holding members 40 are disposed adjacent to each other) is of a generally circular shape of a particular diameter (D₃₀). The diameter of the through-hole 31 is generally the same as that of the cleaning-members-mounting portion 11 of the shaft 10, so that the cleaning-members-mounting portion 11 can be made to pass through the through-holes 31 of the cleaning members 30 when the cleaning members 30 are attached to the shaft 10. Incidentally, the cleaning members 30 are made of felt in this embodiment.

On the other hand, each holding member 40 is made of a hard material; has a cylindrical through-hole 41 in its approximately central area; has a smaller diameter (D₄₀) than the diameter of the opening (d) of the cylindrical hollow portion 101 formed in the tool holder 100 (see FIGS. 5 and 6); and is hollow and of a generally-disk-like shape having a continuous annular outside surface. In other words, the outline of a cross-section of this holding member 40 (the shape defined by the periphery of the holding member 40) as taken generally perpendicularly to the direction of back-and-forth movement of the cleaner 1 relative to the hollow portion 101 is of a generally circular shape of a particular diameter (D₄₀). As a result, the outline of the holding member 40 is generally similar to that of the cleaning member 30 and is uniformly reduced in size (D₃₀>D₄₀) as compared to the cleaning member 30. The diameter of the through-hole 41 is generally the same as that of the cleaning-members-mounting portion 11 of the shaft 10 (i.e., the diameter of the through-hole 41 is the same as that of the through-hole 31), so that the cleaning-members-mounting portion 11 can be made to pass through the through-holes 41 of the holding members 40 when the holding members 40 are attached to the shaft 10.

The cleaning members 30 and the holding members 40 can be rearranged and replaced with each other when attached to the cleaning-members-mounting portion 11 of the shaft 10. As an example specifically shown in FIG. 4, the cleaning-members-mounting portion 11 of the shaft 10 is made to pass through the through-holes 41 of two holding members 40, and the base-end side of these two holding members 40 is made to contact the stepped portion 14 of the shaft 10. Next, the cleaning-members-mounting portion 11 with the two holding members 40 placed thereon is made to pass through the through-holes 31 of five cleaning members 30 and make the base-end side of these five cleaning members 30 contact the top-end side of the two holding members 40 which were placed on the cleaning-members-mounting portion 11 earlier. Subsequently, this operation is repeated to place repeating sets of two holding members 40 and five cleaning members 30 in contact with each other on the cleaning-members-mounting portion 11. After placing the last set of two holding members 40, the top end of the cleaning-members-mounting portion 11 extending out of the through-holes of the last set of two holding members 40 is made to engage with the nut 15, so that the cleaning members 30 and the holding members 40 placed on the cleaning-members-mounting portion 11 are clamped and secured by the stepped portion 14 of the shaft 10 and the base-end face of the nut 15, thereby obtaining the cleaner shown in FIG. 1 (the number of stacked cleaning members 30 is five, and the number of stacked holding members is two).

This cleaner 1 is set so that the length (L₁) of the cleaning portion 20 in its back-and-forth movement direction relative to the hollow portion 101 is almost the same as the depth (L₁₀₀) of the hollow portion 101 (described later in detail). Also, a groove 18 is formed between the sets of cleaning members 30 sandwiching one set of holding members 40 because of the difference between the diameter of the cleaning members 30 and that of the holding members 40.

As shown in FIG. 5 in particular, the hollow portion 101 of the tool holder 100 to be cleaned by this cleaner 1 is defined by a cylindrical inside wall surface 102 having an opening diameter (d) and a depth (L₁₀₀). The sectional shape of this inside wall surface 102 as taken generally perpendicularly to the back-and-forth movement direction of the cleaner 1 is of a generally-circular shape of diameter (d). The (circular) outline of the aforementioned cleaning member 30 is uniformly expanded from (D₃₀>d) and is generally similar to the sectional shape of the inside wall surface 102.

When this cleaner 1 is used to clean the inside wall surface 102 defining the hollow portion 101, the user has only to insert the top end of the cleaner 1 into the hollow portion 101 and move the cleaning portion 20 deeper into the hollow portion 101. Although the diameter (D₃₀) of each cleaning member 30 is larger than the diameter of the opening (d) of the hollow portion 101, the cleaning members 30 are pressed by the inside wall surface 102 and thereby elastically change their shape because of their elasticity. As a result, the cleaning members 30 move deeper into the hollow portion 101, while being in close contact with the inside wall surface 102.

Since the outline of each holding member 40 for holding the cleaning members 30 is generally similar to that of each cleaning member 30 as described earlier, the holding members 40 can hold the cleaning members 30 so that the cleaning members 30 can apply uniform pressure to the inside wall surface 102 around the entire periphery of each cleaning member 30. Also, since the sectional shape of the inside wall surface 102 is generally similar to the outline of each cleaning member 30 as described above, the entire inside wall surface 102 receives uniform pressure (pressing force) from the cleaning members 30. As a result, the cleaner 1 can clean the inside wall surface 102 without leaving any areas unclean.

If the cleaning portion 20 is inserted into the hollow portion 101, the existence of the grooves 18 results in spaces being formed between the inside wall surface 102 and the cleaning portion 20. However, since each cleaning member 30 has a continuous annular outside surface as described above and this outside surface comes into close contact with the inside wall surface 102 in its circumferential direction without leaving any space between the outside surface of the cleaning member 30 and the inside wall surface 102, the inside wall surface 102 can be cleaned with certainty simply by moving the cleaner 1 back and forth. The objects (such as dirt) removed by the cleaning members 30 from the inside wall surface 102 are retained (remain) in the grooves 18. Therefore, the removed objects retained in the grooves 18 can be easily discharged out of the hollow portion 101 by pulling the cleaning portion 20 out of the hollow portion 101.

The cleaning members 30 and the holding members 40 of the cleaner 1 can be easily pulled out of the shaft 10 by loosening and removing the nut 15, so that the cleaning members 30 and the holding members 40 can be rearranged or exchanged with each other. Therefore, if the inside wall surface 102 is only slightly dirty and the pressure (force) applied against the inside wall surface 102 needs to be reduced, the user has only to rearrange the cleaning members 30 and the holding members 40 so that the number of cleaning members 30 to be stacked is reduced as shown in FIG. 7 or FIG. 8.

FIG. 7 shows the cleaner 1 on which repeating sets of one cleaning member 30 and one holding member 40 are arranged. In this case, the cleaning members 30, each of which is independently placed (the number of stacked cleaning members 30 is one), tend to elastically change their shape more easily than the case where sets of cleaning members 30, each set composed of five cleaning members 30, are provided as shown in FIG. 1 (the number of stacked cleaning members 30 is five). Consequently, the pressure (force) applied against the inside wall surface 102 can be reduced as compared to the case shown in FIG. 1.

FIG. 8 shows the cleaner 1 on which repeating sets of two cleaning members 30 and two holding members 40 are arranged. In this case, it is more difficult for the cleaning members 30 where two cleaning members 30 constitute one set (the number of stacked cleaning members 30 is two as shown in FIG. 8), to elastically change their shape than the cleaning members 30, each of which is independently placed (see FIG. 7). Consequently, the pressure (force) applied against the inside wall surface 102 can be increased compared to the case shown in FIG. 7. Also, the cleaning members 30 in the case where two cleaning members 30 constitute one set as shown in FIG. 8, tend to elastically change their shape more easily than the case where five cleaning members 30 constitute one set as shown in FIG. 1. Therefore, the pressure (force) applied against the inside wall surface 102 can be reduced as compared to the case shown in FIG. 1.

If the pressure (force) applied against the inside wall surface 102 needs to be increased more than the case shown in FIG. 1, the cleaning members 30 may be placed by having more than five cleaning members 30 constituting one set.

As described above, the level of pressure (force) applied against the inside wall surface 102 can be adjusted by adjusting the number of cleaning members 30 and holding members 40 used. As a result, the cleaner 1 can clean the inside wall surface 102 by applying optimum pressing force depending on how dirty the inside wall surface 102 is.

Since the cleaning members 30 are made of elastic material, they can properly clean the inside wall surface of any shape other than a cylindrical shape. In this case, if the outline of each cleaning member 30 corresponds to, or is generally similar to, the peripheral shape of the inside wall surface defining the hollow portion, the cleaner 1 can clean the inside wall surface even better. Also, the elasticity of the elastic material for the cleaning members may be changed according to the shape of the inside wall surface to be cleaned (the shape of the hollow portion), or according to the outline of the cleaning member so that the cleaning members can clean the inside wall surface even more effectively.

The cleaner 1 according to the present invention can reliably clean the inside wall surface 102 of the hollow portion 101 simply by moving the cleaner 1 back and forth relative to the hollow portion 101. However, it is a matter of course that the cleaner 1 may be rotated around the shaft 10 (serving as the rotational axis) relative to the hollow portion 101.

This embodiment described the case where felt is used as the elastic material the cleaning members 30 are made of. However, the material for the cleaning members 30 is not limited to felt; and there is no particular limitation on the type of material, such as sponge or woven fabric, as long as the material can give elasticity to the cleaning members 30 when they are made into the cleaning members 30, and as long as the material can remove dirt attached to the inside wall surface 102 of the hollow portion 101.

This embodiment also described the case where the length (L₁) of the cleaning portion 20 in the back-and-forth movement direction relative to the hollow portion 101 is set to be almost the same as the depth (L₁₀₀) of the hollow portion 101. However, the length (L₁) of the cleaning portion 20 is not limited to the above example, and can be set as desired.

The number of cleaning members 30 to be set can be decided arbitrarily.

This embodiment described the case where the external thread 12 is formed at the top end of the shaft 10, and this external thread 12 is made to engage with the internal thread 16 formed in the nut 15, so that the cleaning members 30 and the holding members 40 are secured to the cleaning-members-mounting portion 11 of the shaft 10. However, the configuration of the cleaner 1 is not limited to the above example. As shown in FIG. 9, the cleaning-members-mounting portion 11 which is a component of the shaft 10 may be composed of a bolt, and an internal thread 42 for engaging with an external thread 41 formed on the base-end side of the cleaning-members-mounting portion 11 (bolt) may be formed at the top end of the grip 13. In this case, the cleaning members 30 and the holding members 40 are secured by first inserting a desired number of holding members 40 and cleaning members 30 (in the same manner as described in the aforementioned embodiment) to the cleaning-members-mounting portion 11 (bolt) from its base-end side (where the external thread 41 is formed), then inserting a bolt 45 to the cleaning-members-mounting portion 11 (bolt), and finally having the external thread 41 formed on the cleaning-members-mounting portion 11 (bolt) engage with the internal thread 42 formed in the grip 13. In this case, the base-end face 44 of a head 43 of the cleaning-members-mounting portion 11 (bolt) functions as the aforementioned stepped portion 14.

As shown in FIG. 10, an internal thread 52 for engaging with an external thread 52 formed on a bolt 51 may be formed in the top end of the cleaning-members-mounting portion 11, and the bolt 51 may be used instead of the nut 15 to secure the cleaning members 30 and the holding members 40 to the cleaning-members-mounting portion 11 of the shaft 10.

Furthermore, the shape of the grip 13 to be held by a user can be changed arbitrarily as desired.

### BRIEF DESCRIPTION OF THE DRAWINGS

FIG. 1 is a partly sectional side view of a cleaner according to an embodiment of the present invention.

FIG. 2 is a cross-sectional view of the cleaner shown in FIG. 1 as taken along line II-II.

FIG. 3 is a cross-sectional view of the cleaner shown in FIG. 1 as taken along line III-III.

FIG. 4 is an exploded perspective view of the cleaner shown in FIG. 1.

FIG. 5 is a cross-sectional view of part of a tool holder having a hollow portion to be cleaned by the cleaner according to this embodiment.

FIG. 6 is a cross-sectional view showing the state where the cleaner according to this embodiment is inserted into the hollow portion of the tool holder shown in FIG. 5.

FIG. 7 is a partly sectional view of the cleaner shown in FIG. 1, illustrating the state where cleaning members and holding members of the cleaner have been rearranged.

FIG. 8 is a partly sectional view of the cleaner shown in FIG. 1, illustrating the state where the cleaning members and the holding members of the cleaner have been rearranged.

FIG. 9 is a cross-sectional view of part of a cleaner according to another embodiment of the invention.

FIG. 10 is a cross-sectional view of part of a cleaner according to another embodiment of the invention.

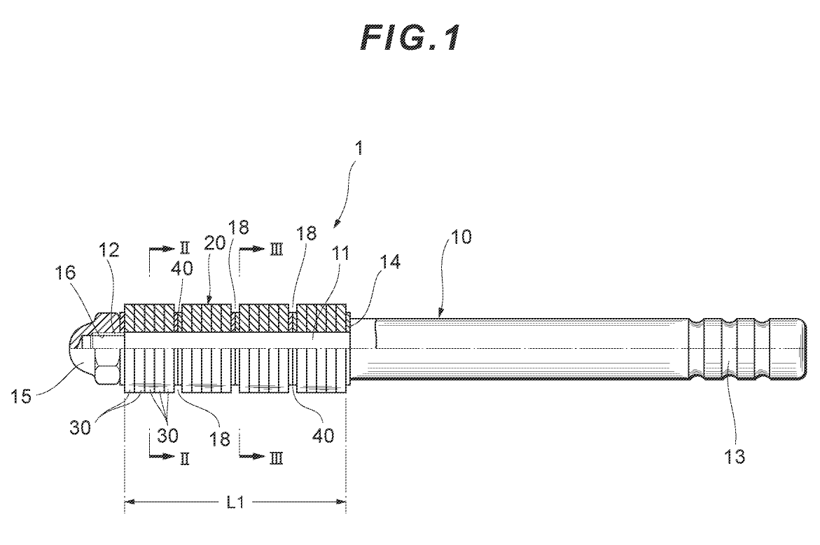

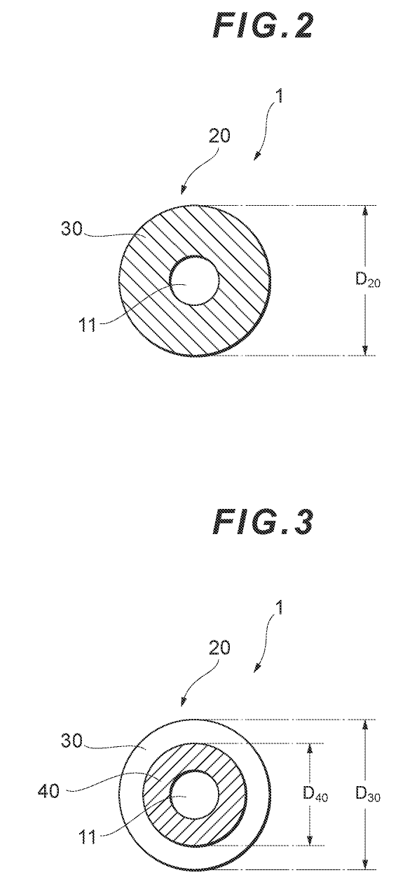

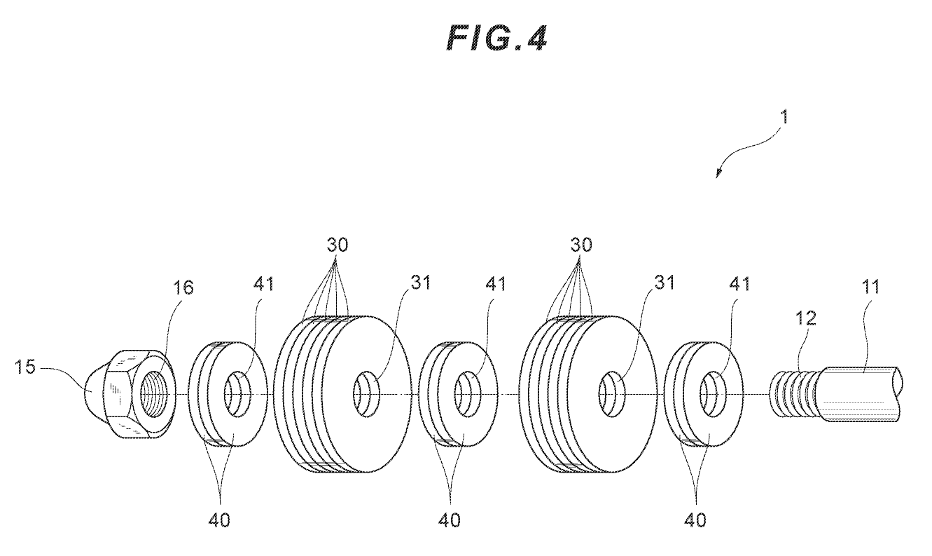

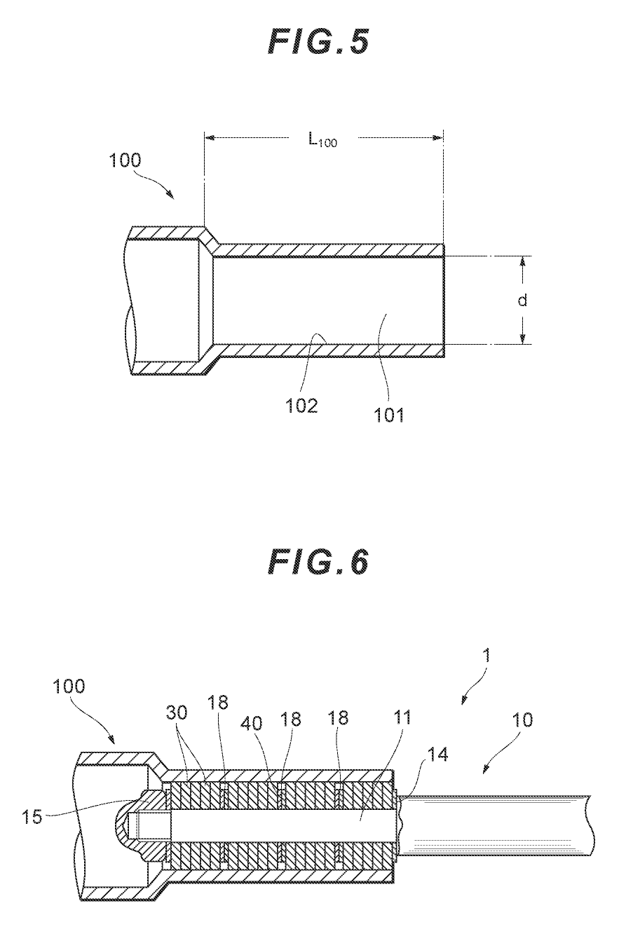

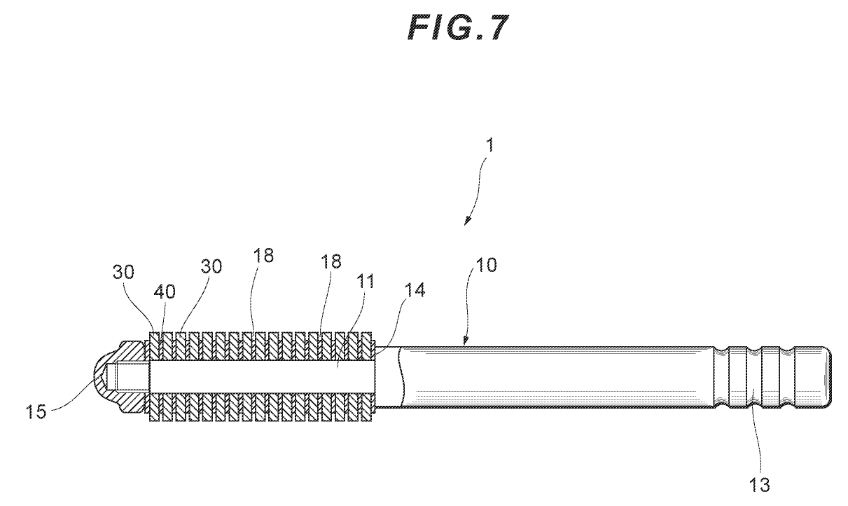

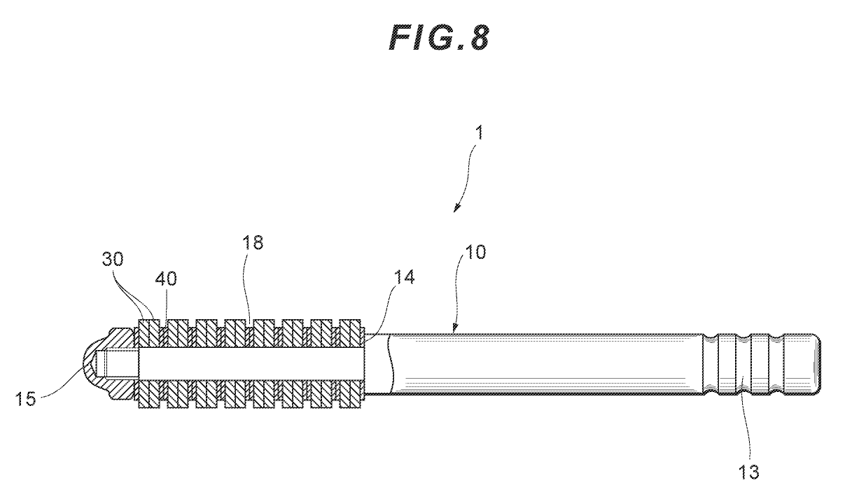

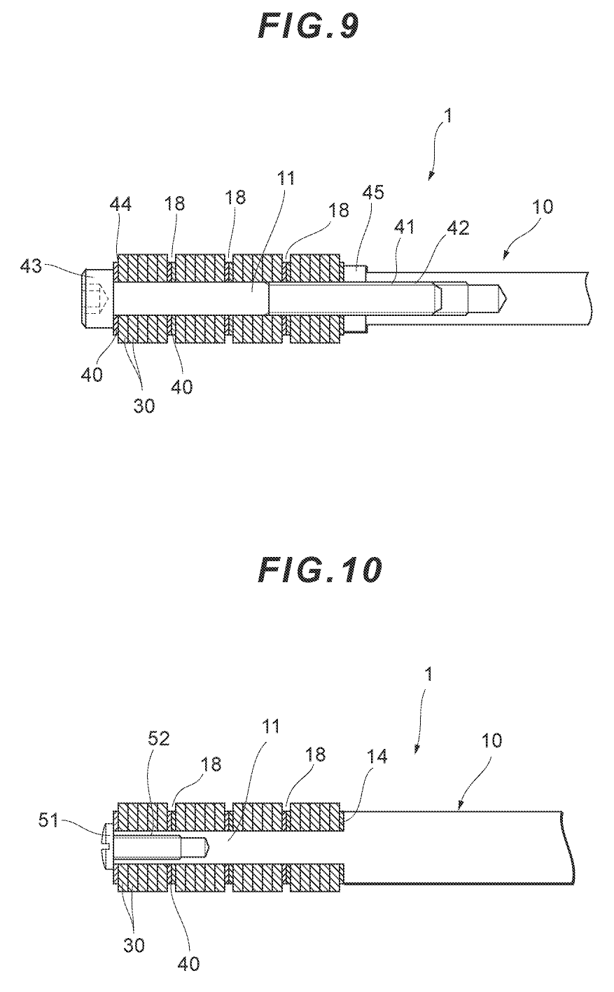

The description of the main reference numerals used in FIGS. 1 to 10 is as follows: “1” represents a “cleaner”; “10” represents a “shaft”; “11” represents a “cleaning-members-mounting portion”; “13” represents a “grip”; “18” represents a “groove”; “20” represents a “cleaning portion”; “30” represents “cleaning members”; “40” represents “holding member(s)”; “100” represents a “tool holder”; “101” represents a “hollow portion”; and “102” represents an “inside wall surface.”

What is claimed is:

1. A cleaner for cleaning an inside wall surface defining a hollow portion, the cleaner comprising:
a shaft; and
a cleaning portion attached around the outside surface of the shaft;
wherein the cleaning portion includes:
a plurality of cleaning members, each of which is made of an elastic material, has a larger diameter than the diameter of an opening of the hollow portion, and has a continuous annular outside surface; and
a holding member for holding the cleaning members and having a smaller diameter than the diameter of the opening of the hollow portion; and
wherein the cleaning members and the holding member can be rearranged and replaced with each other when attached to the shaft.

2. The cleaner according to claim 1, wherein the cross-sectional outline of the holding member as taken generally perpendicularly to a back-and-forth movement direction of the cleaner relative to the hollow portion is generally similar to that of each cleaning member.
